(19) United States
(12) Patent Application Publication
(10) Pub. No.: US 2023/0231637 A1
(43) Pub. Date: Jul. 20, 2023

(54) CHANNEL STATE INFORMATION REPORTS AND CHANNEL STATE INFORMATION INTERFERENCE MEASUREMENT REPORTS ASSOCIATED WITH JOINT SENSING AND COMMUNICATION SERVICES

(71) Applicant: QUALCOMM Incorporated, San Diego, CA (US)

(72) Inventors: Qiaoyu LI, Beijing (CN); Hao XU, Beijing (CN); Yu ZHANG, San Diego, CA (US); Chao WEI, Beijing (CN); Min HUANG, Beijing (CN); Jing DAI, Beijing (CN)

(21) Appl. No.: 17/998,414

(22) PCT Filed: Jun. 2, 2021
(86) PCT No.: PCT/CN2021/097865

§ 371 Date: Nov. 10, 2022

(30) Foreign Application Priority Data
Jun. 30, 2020 (WO) PCTCN2020099113
Jun. 30, 2020 (WO) PCTCN2020099118

(51) Int. Cl. H04B 17/345

(52) U.S. Cl. CPC H04B 17/345

(57) ABSTRACT

Various aspects of the present disclosure generally relate to wireless communication. In some aspects, a user equipment may receive one or more reference signals associated with a sensing signal, and transmit a sensing interference report that indicates one or more parameters for reducing interference for the sensing signal. Numerous other aspects are provided.

### CROSS-REFERENCE TO RELATED APPLICATION

This patent application claims priority to Patent Cooperation Treaty (PCT) Application No. PCT/CN2020/099113, filed on Jun. 30, 2020, entitled “CHANNEL STATE INFORMATION REPORTS AND CHANNEL STATE INFORMATION INTERFERENCE MEASUREMENT REPORTS ASSOCIATED WITH JOINT SENSING AND COMMUNICATION SERVICES,” and assigned to the assignee hereof, and this patent application claims priority to PCT Application No. PCT/CN2020/099118, filed on Jun. 30, 2020, entitled “SENSING INTERFERENCE REPORTS,” and assigned to the assignee hereof. The disclosure of the prior applications are considered part of and are incorporated by reference in this patent application.

### FIELD OF THE DISCLOSURE

Aspects of the present disclosure generally relate to wireless communication and to techniques and apparatuses for transmitting and/or receiving channel state information reports and interference measurement reports associated with joint sensing and communication services.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a user equipment (UE), may include determining non-zero power channel state information (NSP-CSI) based at least in part on a first reference signal and interference of a second reference signal that is associated with a sensing signal; and transmitting a CSI report that is based at least in part on a measurement of the first reference signal and the interference of the second reference signal.

In some aspects, a method of wireless communication, performed by a base station, may include transmitting a first reference signal and a second reference signal that is associated with a sensing signal; and receiving a CSI report that is based at least in part on a measurement of the first reference signal and interference of the second reference signal.

In some aspects, a user equipment for wireless communication may include a memory and one or more processors coupled to the memory. The memory and the one or more processors may be configured to determine CSI based at least in part on a first reference signal and interference of a second reference signal that is associated with a sensing signal; and transmit a CSI report that is based at least in part on a measurement of the first reference signal and the interference of the second reference signal.

In some aspects, a base station for wireless communication may include a memory and one or more processors coupled to the memory. The memory and the one or more processors may be configured to transmit a first reference signal and a second reference signal that is associated with a sensing signal; and receive a CSI report that is based at least in part on a measurement of the first reference signal and interference of the second reference signal.

In some aspects, a non-transitory computer-readable medium may store one or more instructions for wireless communication. The one or more instructions, when executed by one or more processors of a UE, may cause the one or more processors to determine CSI based at least in part on a first reference signal and interference of a second reference signal that is associated with a sensing signal; and transmit a CSI report that is based at least in part on a measurement of the first reference signal and the interference of the second reference signal.

In some aspects, a non-transitory computer-readable medium may store one or more instructions for wireless communication. The one or more instructions, when executed by one or more processors of a base station, may cause the one or more processors to transmit a first reference signal and a second reference signal that is associated with a sensing signal; and receive a CSI report that is based at least in part on a measurement of the first reference signal and interference of the second reference signal.

In some aspects, an apparatus for wireless communication may include means for determining CSI based at least in part on a first reference signal and interference of a second reference signal that is associated with a sensing signal; and means for transmitting a CSI report that is based at least in part on a measurement of the first reference signal and the interference of the second reference signal.

In some aspects, an apparatus for wireless communication may include means for transmitting a first reference signal and a second reference signal that is associated with a sensing signal; and means for receiving a CSI report that is based at least in part on a measurement of the first reference signal and interference of the second reference signal.

In some aspects, a method of wireless communication, performed by a UE, may include receiving one or more reference signals associated with a sensing signal; and transmitting a sensing interference report that indicates one or more parameters for reducing interference for the sensing signal.

In some aspects, a method of wireless communication, performed by a base station, may include transmitting one or more reference signals associated with a sensing signal; and receiving a sensing interference report that indicates one or more parameters for reducing interference for the sensing signal.

In some aspects, a UE for wireless communication may include a memory and one or more processors coupled to the memory. The memory and the one or more processors may be configured to receive one or more reference signals associated with a sensing signal; and transmit a sensing interference report that indicates one or more parameters for reducing interference for the sensing signal.

In some aspects, a base station for wireless communication may include a memory and one or more processors coupled to the memory. The memory and the one or more processors may be configured to transmit one or more reference signals associated with a sensing signal; and receive a sensing interference report that indicates one or more parameters for reducing interference for the sensing signal.

In some aspects, a non-transitory computer-readable medium may store one or more instructions for wireless communication. The one or more instructions, when executed by one or more processors of a UE, may cause the one or more processors to receive one or more reference signals associated with a sensing signal; and transmit a sensing interference report that indicates one or more parameters for reducing interference for the sensing signal.

In some aspects, a non-transitory computer-readable medium may store one or more instructions for wireless communication. The one or more instructions, when executed by one or more processors of a base station, may cause the one or more processors to transmit one or more reference signals associated with a sensing signal; and receive a sensing interference report that indicates one or more parameters for reducing interference for the sensing signal.

In some aspects, an apparatus for wireless communication may include means for receiving one or more reference signals associated with a sensing signal; and means for transmitting a sensing interference report that indicates one or more parameters for reducing interference for the sensing signal.

In some aspects, an apparatus for wireless communication may include means for transmitting one or more reference signals associated with a sensing signal; and means for receiving a sensing interference report that indicates one or more parameters for reducing interference for the sensing signal.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, RF chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of space division multiplexing sensing signals and communication signals, in accordance with the present disclosure.

FIGS. 4 and 5 diagrams illustrating examples associated with transmitting and/or receiving channel state information reports and channel state information interference measurement reports associated with joint sensing and communication services, in accordance with the present disclosure.

FIGS. 6 and 7 are diagrams illustrating example processes associated with transmitting and/or receiving channel state information reports and channel state information interference measurement reports associated with joint sensing and communication services, in accordance with the present disclosure.

FIGS. 8 and 9 diagrams illustrating examples associated with transmitting and/or receiving sensing interference reports, in accordance with the present disclosure.

FIGS. 10 and 11 are diagrams illustrating example processes associated with transmitting and/or receiving sensing interference reports, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

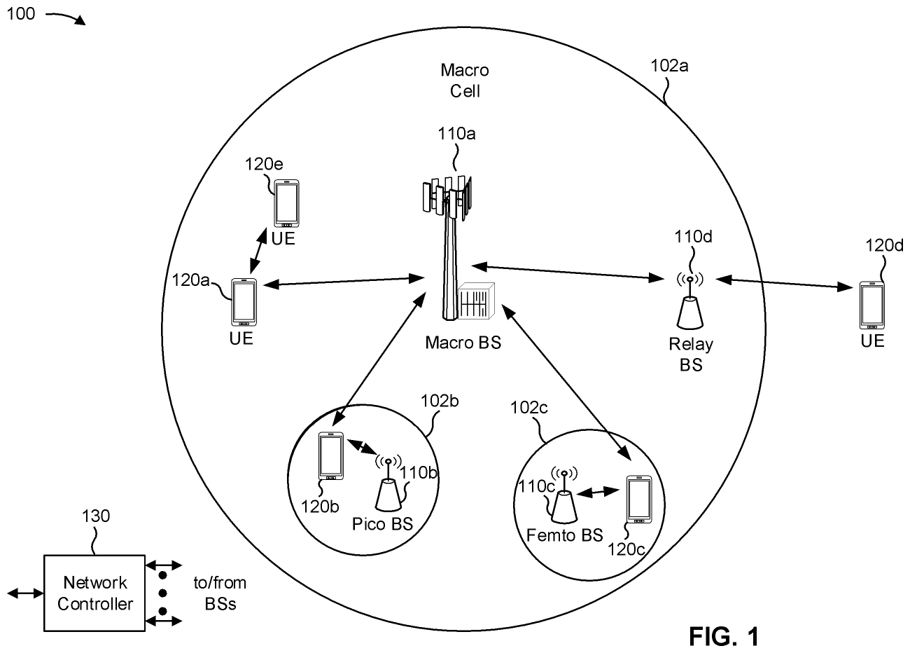

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

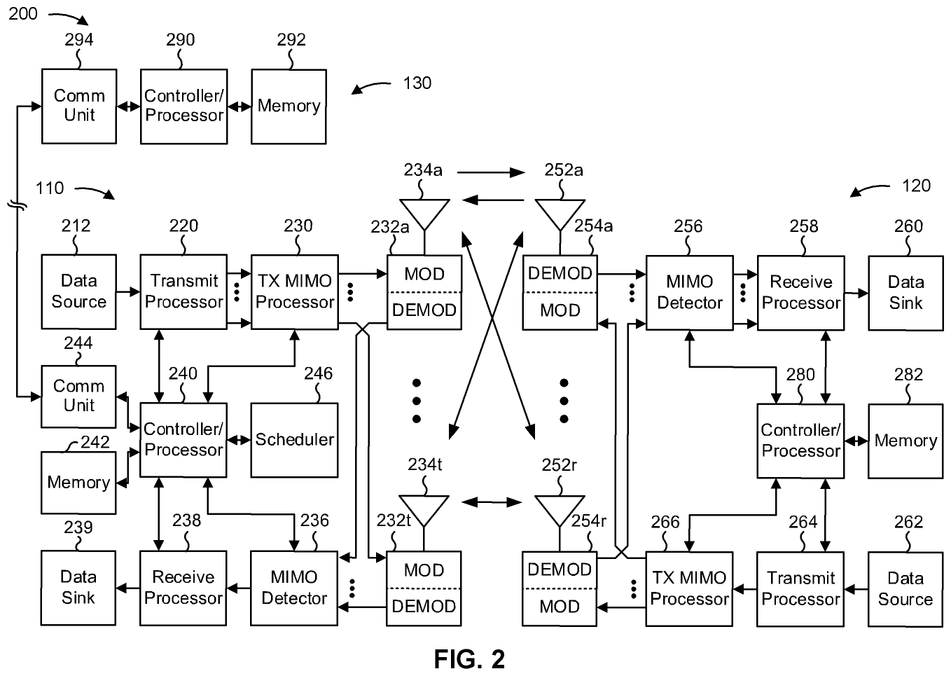

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

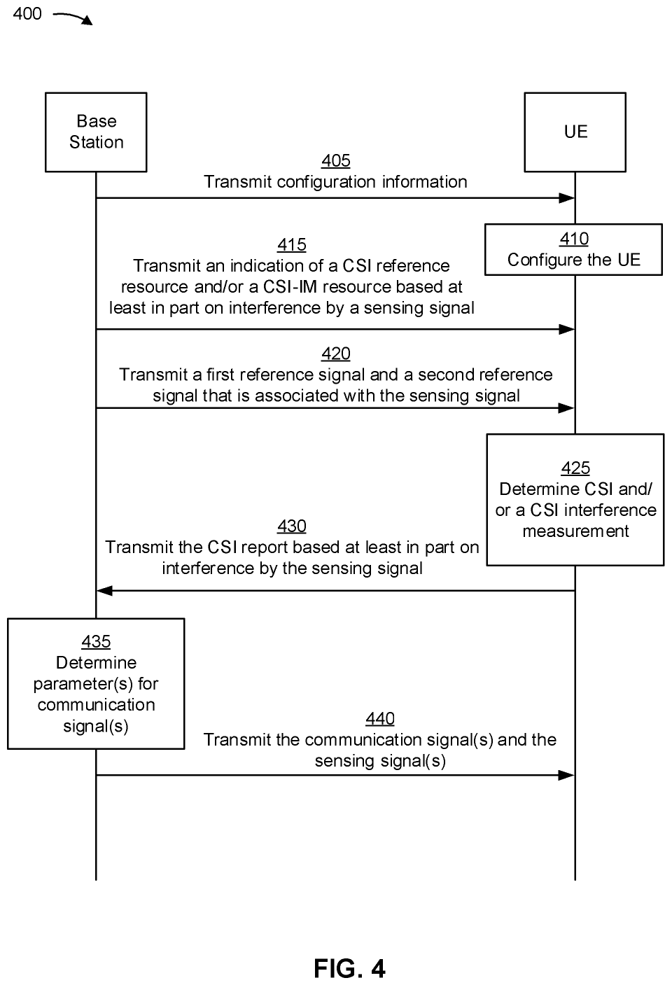

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-11).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-11).

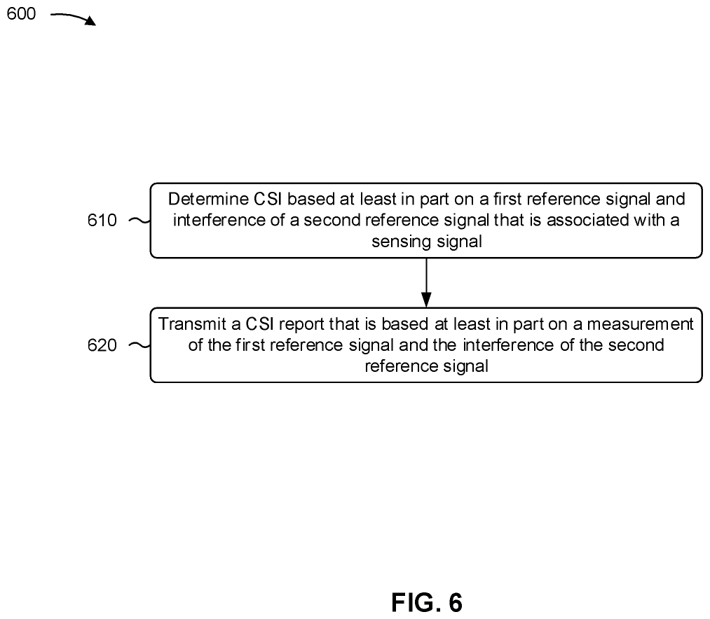

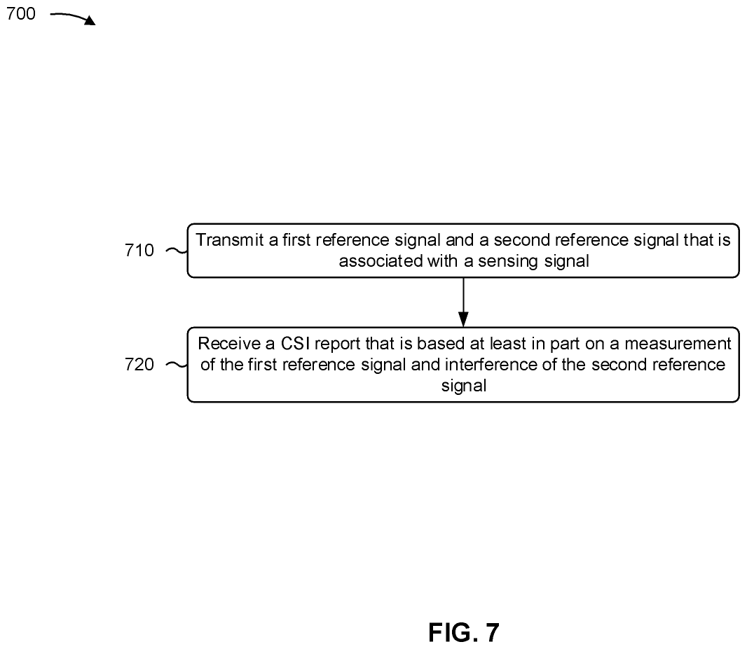

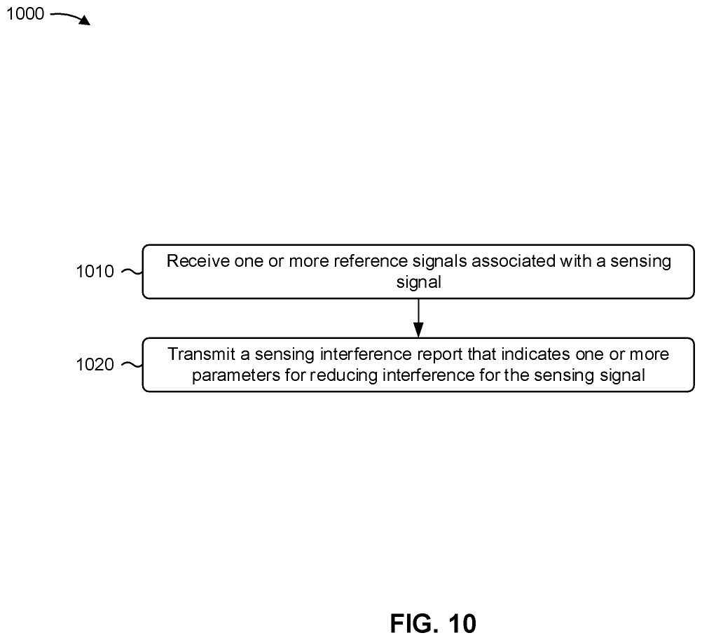

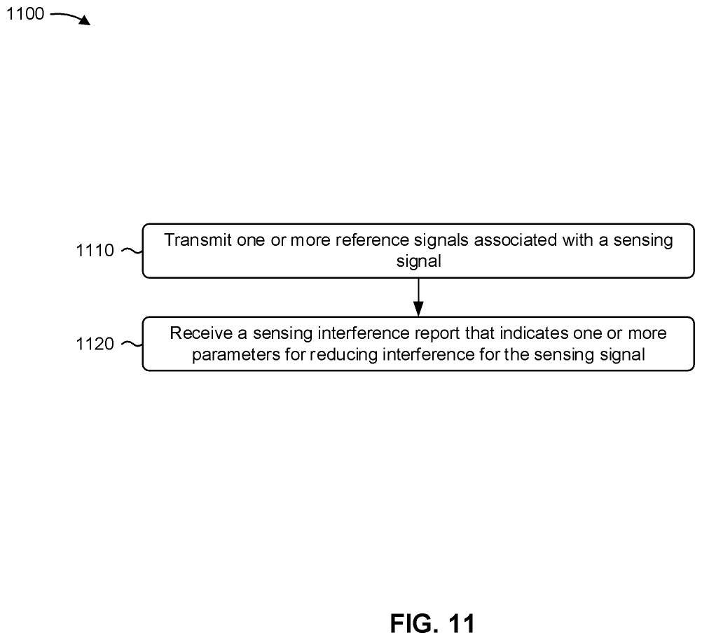

Controller/processor 240 of base station 110, controller/processor 280 of UE 120, and/or any other component(s) of FIG. 2 may perform one or more techniques associated with transmitting and/or receiving channel state information (CSI) reports and interference measurement reports associated with joint sensing and communication services, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, process 1000 of FIG. 10, process 1100 of FIG. 11, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, process 1000 of FIG. 10, process 1100 of FIG. 11, and/or other processes as described herein. In some aspects, executing instructions may include running the instructions, converting the instructions, compiling the instructions, and/or interpreting the instructions, among other examples.

In some aspects, UE 120 may include means for determining CSI based at least in part on a first reference signal and interference of a second reference signal that is associated with a sensing signal, means for transmitting a CSI report that is based at least in part on a measurement of the first reference signal and the interference of the second reference signal, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting a first reference signal and a second reference signal that is associated with a sensing signal; means for receiving a CSI report that is based at least in part on a measurement of the first reference signal and interference of the second reference signal, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

In some aspects, UE 120 may include means for receiving one or more reference signals associated with a sensing signal, means for transmitting a sensing interference report that indicates one or more parameters for reducing interference for the sensing signal, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting one or more reference signals associated with a sensing signal, means for receiving a sensing interference report that indicates one or more parameters for reducing interference for the sensing signal, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

Some wireless networks may use nodes, such as base stations, to jointly perform sensing services and communication services (e.g., joint SensComm services). The sensing services may include object detection that may be used, for example, to improve the communication services or to improve other services. For example, a UE that receives a sensing signal may use the sensing signal to detect objects for services such as assisted driving and/or steering of a vehicle (e.g., to avoid collisions).

Jointly performing sensing services and communication services may support a synergistic design of communications systems and sensing systems (e.g., radio detection and ranging (radar) and/or the like) that may use a common spectrum and/or common components. However, sensing signals and communication signals may have different characteristics, which may cause difficulty for managing interference between the sensing signals and the communication signals. For example, communication signals may use OFDM waveforms, and sensing signals may use impulsive signals, frequency-modulated continuous waveforms (FMCW), phase-modulated continuous waveforms (PMCW), and/or the like.

Differences in characteristics of sensing services and communication services may cause difficulty for managing interference between the sensing signals and the communication signals and/or to maintain integrity of the sensing service and/or the communication service. For example, precoding for a communication signal may be adjusted slot-by-slot to improve a signal-to-interference-plus-noise ratio (SINR). Sensing services may be improved by maintaining a constant precoding for transmissions of sensing signals over multiple slots. For example, maintaining a constant precoding for multiple slots may improve resolution of object detection. In some examples, only signals having a same precoding may be coherently used for Doppler estimation, and coherent Doppler estimation may require sensing signals transmitted for a duration that is longer than a slot of the communication signals.

Using time division multiplexing (TDM) and/or frequency division multiplexing (FDM) to transmit the communication signals and the sensing signals may reduce interference between the communication signals and the sensing signals. However, using TDM may lower Doppler resolution of the one or more sensing signals and may cause scheduling restrictions for the one or more communication signals (e.g., to avoid simultaneous transmissions). Similarly, using FDM may cause scheduling restrictions for the one or more communication signals (e.g., to avoid using same or related frequencies) and/or may degrade range resolution of the one or more sensing signals.

Although using space division duplexing (SDM) may cause difficulty for managing interference between the sensing signals and the communication signals and/or to maintain integrity of the sensing service and/or the communication service, using SDM may allow a transmitting node to be spatially selective, to transmit the one or more communication signals and the one or more sensing signals using different beams to reduce interference without lowering Doppler resolution of the one or more sensing signals, degrading range resolution, and/or introducing scheduling restrictions as described when using FDM or SDM.

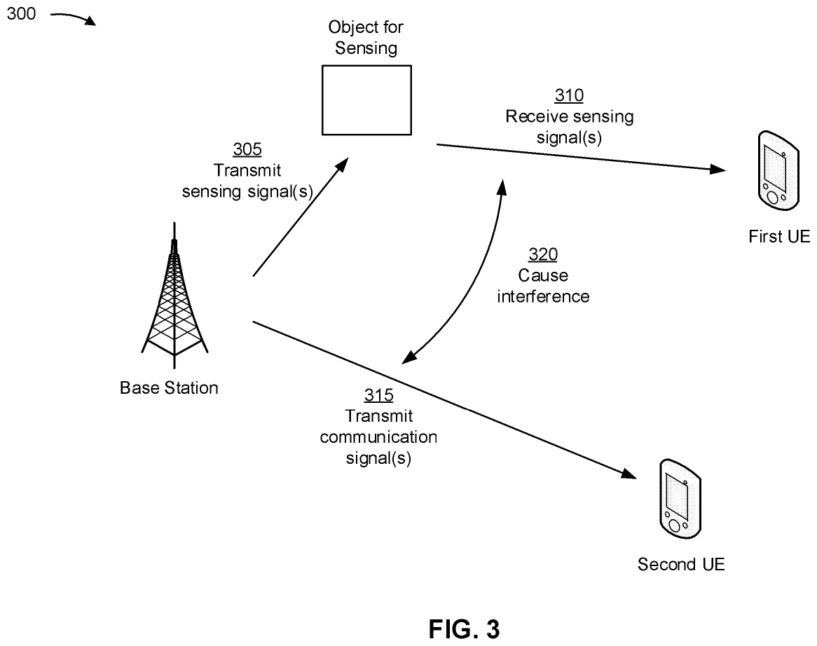

FIG. 3 is a diagram illustrating an example 300 of SDM sensing signals and communication signals, in accordance with the present disclosure. As shown in FIG. 3, a base station may transmit signals for reception by a first UE, a second UE, and/or the like. The base station, the first UE, and the second UE may be part of a wireless network.

As shown by reference number 305, the base station may transmit one or more sensing signals for reception by the first UE. The one or more sensing signals may be used to detect an object based at least in part on the one or more signals interacting with the object between transmission of the one or more signals by the base station and reception of the one or more signals by the first UE. For example, the object may cause reflection, refraction, a Doppler effect, and/or the like to the one or more signals.

As shown by reference number 310, the base station may transmit one or more communication signals to the second UE. For example, the base station may transmit one or more physical downlink control channel (PDCCH) communications, physical downlink shared channel (PDSCH) communications, reference signals, and/or the like.

As shown by reference number 315, the one or more sensing signals may cause interference with the one or more communication signals, and/or the one or more communication signals may cause interference with the one or more sensing signals.

As indicated above, FIG. 3 is provided as an example. Other examples may differ from what is described with regard to FIG. 3.

As described above, a node (e.g., a base station) that jointly performs sensing services and communication services using SDM may provide advantages over TDM and FDM, such as improved Doppler resolution, range resolution, and scheduling. However, a node using SDM may have difficulty managing interference between sensing signals and communication signals based at least in part on, for example, different characteristics of the sensing signals and the communication signals. For example, the node may impulsively transmit a sensing signal during some symbols of a CSI reference resource and not transmit the sensing signal during remaining symbols of the CSI reference resource. This may distort a determination of SINR for the CSI reference resource and/or cause the UE to transmit an incorrect or incomplete indication of SINR based at least in part on the sensing signal, which may cause the node to consume power, communication, and/or network resources to transmit communications to the UE using an unnecessarily high transmission power, to detect and recover from communication errors from transmitting communications without sufficient power, and/or the like.

As described herein, a UE that uses a communication service (e.g., a sensing UE), based at least in part on communication signals from a base station that provides sensing signals for a sensing service, may provide a CSI report that indicates one or more metrics that are based at least in part on measurement of a sensing signal and/or interference from the sensing signal. For example, the UE may be configured with a CSI reference resource that is associated with one or more communication beams. Additionally and/or alternatively, the UE may be configured with a CSI-IM resource that is associated with a sensing signal (e.g., an object detection signal). In some aspects, the UE may use the CSI reference resource to measure a first reference signal associated with communication between the UE and the base station and/or the CSI-IM resource to measure interference caused by the sensing signal. The UE may use the measurements to generate a CSI report for transmission to the base station.

The CSI-IM resource may indicate a waveform (e.g., an impulsive waveform, an FMCW, a PMCW, and/or the like) of the sensing signal and/or a reference signal associated with the sensing signal. In some aspects, the CSI-IM resource and/or the CSI reference resource may indicate a basis for determining metrics of the CSI based at least in part on the waveform of the sensing signal and/or the reference signal associated with the sensing signal. For example, the UE may determine the metrics of the CSI (e.g., a rank index, a precoding matrix index (PMI), a CQI, and/or the like) based at least in part on the sensing signal and/or the reference signal associated with the sensing signal having an impulsive waveform that is transmitted on some symbols of the CSI reference resource and not transmitted on remaining symbols of the CSI reference resource.

In some aspects, the UE may transmit separate sets of metrics of the CSI based at least in part on measurements associated with symbols during which the sensing signal and/or the reference signal associated with the sensing signal (e.g., as identified in the CSI-IM resource) interfere, and measurements associated with symbols during which the sensing signal and/or the reference signal associated with the sensing signal do not interfere. In some aspects, the UE may report a joint set of metrics of the CSI that accounts for interference of the sensing signal, the reference signal associated with the sensing signal, and/or a waveform of the sensing signals.

Based at least in part on the UE transmitting the CSI report that is based at least in part on interference of the sensing signal, the reference signal associated with the sensing signal, and/or a waveform of the sensing signals, the base station may have information to more accurately select one or more parameters for transmitting a communication signal to the UE. This may allow the base station to select a transmission power parameter, for example, that is appropriate based at least in part on an SINR that accounts for the sensing signal. This may conserve computing, network, communication, and/or power resources that may otherwise be consumed by transmitting communications to the UE using an unnecessarily high transmission power, detecting and recovering from communication errors from transmitting communications without sufficient power, and/or the like.

FIG. 4 is a diagram illustrating an example 400 associated with transmitting and/or receiving CSI reports associated with joint sensing and communication services, in accordance with the present disclosure. As shown in FIG. 4, a base station (e.g., base station 110) may communicate with a UE (e.g., UE 120). The base station and the UE may be part of a wireless network (e.g., wireless network 100). In some aspects, the UE may be configured to use one or more communication signals from the base station to support a communication service. The base station may also support a sensing service (e.g., an object detection service).

As shown by reference number 405, the base station may transmit, and the UE may receive, configuration information. In some aspects, the UE may receive the configuration information from another device (e.g., from another base station, another UE, and/or the like), from a specification of a communication standard, and/or the like. In some aspects, the UE may receive the configuration information via one or more of radio resource control (RRC) signaling, medium access control (MAC) signaling (e.g., MAC control elements (MAC CEs)), and/or the like. In some aspects, the configuration information may include an indication of one or more configuration parameters (e.g., already known to the UE) for selection by the UE, explicit configuration information for the UE to use to configure the UE, and/or the like.

In some aspects, the configuration information may indicate that the UE is to receive one or more reference signals associated with a communication signal (e.g., including a non-zero power CSI reference signal (NZP-CSI-RS), a sensing signal and/or a reference signal associated with the sensing signal, and/or the like), measure the one or more reference signals, determine a CSI report based at least in part on the one or more reference signals, transmit the CSI report, and/or the like. In some aspects, the configuration information may indicate that the UE is to receive the one or more reference signals based at least in part on a CSI reference resource and/or a CSI-IM measurement.

As shown by reference number 410, the UE may configure the UE for communicating with the base station. In some aspects, the UE may configure the UE based at least in part on the configuration information. In some aspects, the UE may be configured to perform one or more operations described herein.

As shown by reference number 415, the base station may transmit, and the UE may receive, an indication of an CSI reference resource and/or a CSI-IM resource to use for measuring the one or more reference signals. In some aspects, the CSI reference resource may be associated with a reference signal (e.g., an NZP-CSI-RS) of the communication signal. In some aspects, the NZP-CSI-RS may identify multiple spatially different beams. In some aspects, the multiple spatially different beams may be associated with different reference signals or transmissions of a same reference signal. In some aspects, the one or more reference signals may include an NZP-CSI-RS, a CSI-IM reference signal, a synchronization signal block (SSB), and/or the like. In some aspects, the one or more reference signals may be time division multiplexed, frequency division multiplexed, and/or the like.

In some aspects, the CSI-IM may indicate enhanced reference signals that may, for example, represent characteristics of waveforms (e.g., impulsive, FMCW, PMCW, and/or the like) such as duty-cycle, periodicity, power, and/or the like of one or more signals. In other words, the CSI-IM may indicate that interference for the communication reference signal may be based at least in part on another reference signal having an indicated waveform type, duty-cycle, periodicity, power metric, and/or the like. For example, the CSI-IM may indicate that a reference signal may be configured to be transmitted impulsively within a proper subset of a set of resources identified in the CSI reference resource and/or the CSI-IM resource.

As shown by reference number 420, the base station may transmit, and the UE may receive, a first reference signal (e.g., associated with communications between the UE and the base station) and a second reference signal that is associated with the sensing signal. The second reference signal may be associated with a waveform that includes a signal transmitted via an ultra-wide bandwidth, an impulsive signal, a signal transmitted using FMCW, or a signal transmitted using PMCW. In some aspects, the first reference signal may include one or more of an NZP-CSI-RS, a CSI-IM reference signal, an SSB, and/or the like. In some aspects, the second reference signal may include one or more transmissions of the sensing signal, one or more reference signals associated with the sensing signal (e.g., having one or more characteristics of the sensing signal such as waveform, duty cycle, power, and/or the like), and/or the like.

In some aspects, the UE may receive a single reference signal (e.g., a single reference signal associated with communication between the UE and the base station), of the one or more reference signals, via multiple spatially different beams. In some aspects, the UE may receive multiple reference signals (e.g., multiple reference signals associated with communication between the UE and the base station), of the one or more reference signals, via the multiple spatially different beams. In some aspects, the UE may receive the single reference signal and/or the multiple reference signals using TDM and/or FDM.

In some aspects, the UE may receive at least one reference signal (e.g., that is associated with the sensing signal) via repeated transmissions using a single beam (e.g., with a same spatial direction). For example, the at least one reference signal may be a repeated NZP-CSI-RS with a same quasi co-location (CQL) type (e.g., QCL-TypeD).

As shown by reference number 425, the UE may determine CSI based at least in part on a measurement of the first reference signal and the interference of the second reference signal. The UE may determine the CSI based at least in part on the first reference signal and interference of the second reference signal as indicated by the one or more of the CSI reference resource or the CSI-IM resource. In some aspects, the UE may determine a first set of CSI parameters for the proper subset of the set of resources and a second set of CSI parameters for resources outside of the proper subset of the set of resources. In some aspects, the UE may determine a joint set of CSI parameters based at least in part on the second reference signal being transmitted impulsively within the proper subset of the set of resources. The CSI parameters may include indications of a rank index, a PMI, a CQI, and/or the like.

As shown by reference number 430, the UE may transmit, and the base station may receive, the CSI report that are based at least in part on interference by the sensing signal. For example, the CSI report may be based at least in part on the measurement of the first reference signal and the interference of the second reference signal.

As shown by reference number 435, the base station may determine one or more parameters for one or more communication signals. For example, the base station may determine one or more parameters for transmitting communication signals to the UE. The one or more parameters may include a beam direction, a transmission power, a modulation order, a rank index, and/or the like.

As shown by reference number 440, the base station may transmit the one or more communication signals and one or more sensing signals. For example, the base station may transmit the one or more communication signals to the UE based at least in part on the one or more parameters indicated in the CSI report.

Based at least in part on the UE transmitting the CSI report accounting for interference by a sensing signal (e.g., with a waveform that is different from a communication signal), the base station may have information to select one or more parameters for transmitting the communication signal to the UE. For example, the base station may select a transmit power, a PMI, a rank, and/or the like that are appropriate based at least in part on the interference by the sensing signal. This may conserve power network resources that may otherwise have been used to detect and recover from communication errors from transmitting communications without sufficient power, and/or the like.

As indicated above, FIG. 4 is provided as an example. Other examples may differ from what is described with regard to FIG. 4.

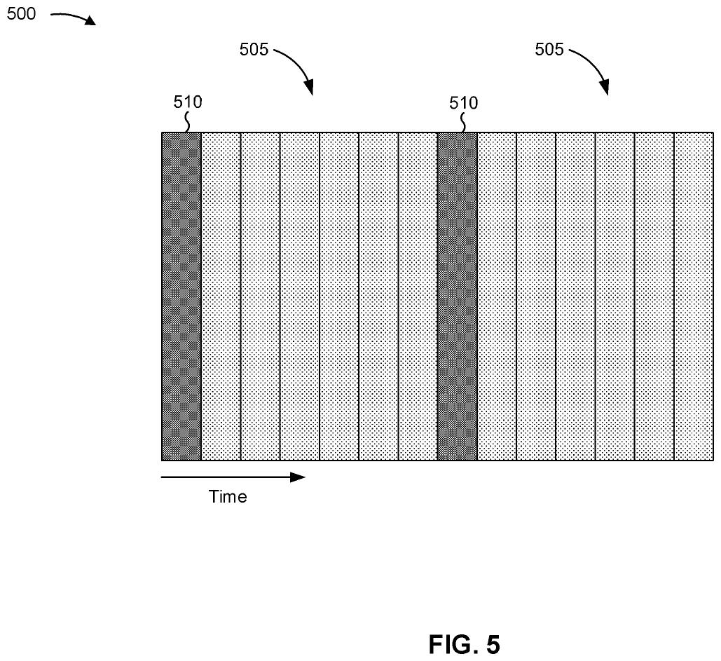

FIG. 5 is a diagram illustrating an example 500 associated with transmitting and/or receiving CSI reports associated with joint sensing and communication services, in accordance with the present disclosure.

As shown by reference number 505, a CSI reference resource and/or a CSI-IM resource may identify a set of symbols for receiving one or more reference signals associated with communication signals.

As shown by reference number 510, the CSI reference resource and/or the CSI-IM resource may identify a proper subset of the set of symbols (e.g., including some, but not all symbols of the set) during which impulsive interference is expected. For example, the CSI reference resource and/or the CSI-IM resource may indicate that a sensing signal and/or a reference signal associated with the sensing signal is to be transmitted during the proper subset of symbols.

A receiving device (e.g., UE 120) may calculate a rank index, a PMI, a CQI, and/or the like based at least in part on receiving reference signals associated with the CSI reference resource and/or the CSI-IM resource and accounting for the sensing signal and/or the reference signal associated with the sensing signal. In some aspects, the receiving device may determine an impulsive interference pattern based at least in part on the CSI-IM resource that is associated with the CSI reference resource.

In some aspects, the receiving device may report separate sets of rank indexes, PMIs, CQIs, and/or the like for symbols with interference from the sensing signal and for symbols without the interference from the sensing signal. In some aspects, the receiving device may report a single rank index, PMI, CQI, and/or the like after accounting for impulsive interference.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120 and/or the like) performs operations associated with transmitting and/or receiving CSI reports associated with joint sensing and communication services.

As shown in FIG. 6, in some aspects, process 600 may include determining CSI based at least in part on a first reference signal and interference of a second reference signal that is associated with a sensing signal (block 610). For example, the UE (e.g., using receive processor 258, controller/processor 280, memory 282, and/or the like) may determine CSI based at least in part on a first reference signal and interference of a second reference signal that is associated with a sensing signal, as described above.

As further shown in FIG. 6, in some aspects, process 600 may include transmitting a CSI report that is based at least in part on a measurement of the first reference signal and the interference of the second reference signal (block 620). For example, the UE (e.g., using transmit processor 264, controller/processor 280, memory 282, and/or the like) may transmit a CSI report that is based at least in part on a measurement of the first reference signal and the interference of the second reference signal, as described above.

Process 600 may include additional aspects, such as any single aspect or any combination of aspects described below and/or in connection with one or more other processes described elsewhere herein.

In a first aspect, the second reference signal is associated with a waveform that includes one or more of: a signal transmitted via an ultra-wide bandwidth, an impulsive signal, a signal transmitted using FMCW, or a signal transmitted using PMCW.

In a second aspect, alone or in combination with the first aspect, process 600 includes receiving an indication of one or more of a CSI reference resource or a CSI-IM resource, wherein determining the CSI based at least in part on the first reference signal and the interference of the second reference signal includes determining the CSI based at least in part on the first reference signal and the interference of the second reference signal as indicated by the one or more of the CSI reference resource or the CSI-IM resource.

In a third aspect, alone or in combination with one or more of the first and second aspects, the one or more of the CSI reference resource or the CSI-IM resource identifies one or more parameters of the second reference signal, the one or more parameters including one or more of: a waveform type for the sensing signal, a duty-cycle for the sensing signal, a periodicity for the sensing signal, or a power metric for the sensing signal.

In a fourth aspect, alone or in combination with one or more of the first through third aspects, the one or more of the CSI reference resource or the CSI-IM resource indicates that the first reference signal is configured to be transmitted via a set of resources and that the second reference signal is configured to be transmitted impulsively within a proper subset of the set of resources.

In a fifth aspect, alone or in combination with one or more of the first through fourth aspects, determining the CSI based at least in part on the first reference signal and the interference of the second reference signal includes one or more of: determining a first set of CSI parameters for the proper subset of the set of resources and a second set of CSI parameters for resources outside of the proper subset of the set of resources, or determining a joint set of CSI parameters based at least in part on the second reference signal being transmitted impulsively within the proper subset of the set of resources.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110 and/or the like) performs operations associated with transmitting and/or receiving CSI reports associated with joint sensing and communication services.

As shown in FIG. 7, in some aspects, process 700 may include transmitting a first reference signal and a second reference signal that is associated with a sensing signal (block 710). For example, the base station (e.g., using transmit processor 220, controller/processor 240, memory 242, and/or the like) may transmit a first reference signal and a second reference signal that is associated with a sensing signal, as described above.

As further shown in FIG. 7, in some aspects, process 700 may include receiving a CSI report that is based at least in part on a measurement of the first reference signal and interference of the second reference signal (block 720). For example, the base station (e.g., using receive processor 238, controller/processor 240, memory 242, and/or the like) may receive a CSI report that is based at least in part on a measurement of the first reference signal and interference of the second reference signal, as described above.

Process 700 may include additional aspects, such as any single aspect or any combination of aspects described below and/or in connection with one or more other processes described elsewhere herein.

In a first aspect, the second reference signal is associated with a waveform that includes one or more of: a signal transmitted via an ultra-wide bandwidth, an impulsive signal, a signal transmitted using FMCW, or a signal transmitted using PMCW.

In a second aspect, alone or in combination with the first aspect, process 700 includes transmitting an indication of one or more of a CSI reference resource or a CSI-IM resource, wherein the CSI report is based at least in part on the first reference signal and the interference of the second reference signal as indicated by one or more of the CSI reference resource or the CSI-IM resource.

In a third aspect, alone or in combination with one or more of the first and second aspects, the one or more of the CSI reference resource or the CSI-IM resource identifies one or more parameters of the second reference signal, the one or more parameters including one or more of: a waveform type for the sensing signal, a duty-cycle for the sensing signal, a periodicity for the sensing signal, or a power metric for the sensing signal.

In a fourth aspect, alone or in combination with one or more of the first through third aspects, the one or more of the CSI reference resource or the CSI-IM resource indicates that the first reference signal is configured to be transmitted via a set of resources and that the second reference signal is configured to be transmitted impulsively within a proper subset of the set of resources.

In a fifth aspect, alone or in combination with one or more of the first through fourth aspects, the CSI report indicates one or more of a first set of CSI parameters for the proper subset of the set of resources and a second set of CSI parameters for resources outside of the proper subset of the set of resources, or a joint set of CSI parameters based at least in part on the second reference signal being transmitted impulsively within the proper subset of the set of resources.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

As described herein, a UE that uses a sensing service (e.g., a sensing UE), based at least in part on sensing signals from a base station, may provide a report that indicates how interference from a communication signal may be reduced and/or avoided. For example, the UE may be configured with a measurement resource (e.g., an SMR) that is associated with a sensing beam (e.g., an active or already determined sensing beam). Additionally and/or alternatively, the UE may be configured with an interference measurement resource (e.g., an SIMR) that is associated with a communication signal (e.g., a non-precoded communication signal). In some aspects, the UE may use the sensing interference resource to measure one or more reference signals as an interference reference and/or may use the sensing resource to measure one or more reference signals associated with a sensing signal. The UE may use the measurements to generate an interference report for transmission to the base station.

The interference report may include one or more indications of how the base station may reduce and/or avoid interference from the communication signal. For example, the interference report may indicate a modulation order, a request for spatial parameters and/or power parameters for preferred spatial interference directions (e.g., associated with the communication signal) and/or spatial interference directions to be avoided.

Based at least in part on the UE transmitting a report based at least in part on reference signals associated with a sensing signal, the base station may have information to select one or more parameters for transmitting a communication signal to reduce interference, from the communication signal, for the sensing signal. This may allow the base station to use SDM for sensing services and communication services with improved Doppler resolution, range resolution, and scheduling when compared to FDM or TDM.

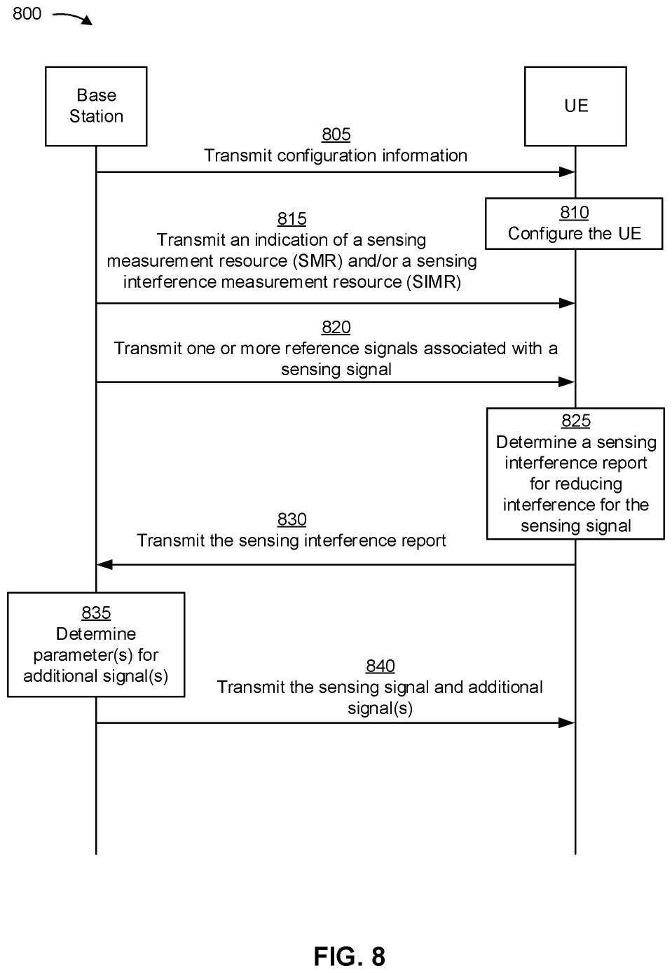

FIG. 8 is a diagram illustrating an example 800 associated with transmitting and/or receiving sensing interference reports, in accordance with the present disclosure. As shown in FIG. 8, a base station (e.g., base station 110) may communicate with a UE (e.g., UE 120). The base station and the UE may be part of a wireless network (e.g., wireless network 100). In some aspects, the UE may be configured to use one or more sensing signals from the base station to support a sensing service (e.g., an object detection service).

As shown by reference number 805, the base station may transmit, and the UE may receive, configuration information. In some aspects, the UE may receive the configuration information from another device (e.g., from another base station, another UE, and/or the like), from a specification of a communication standard, and/or the like. In some aspects, the UE may receive the configuration information via one or more of radio resource control (RRC) signaling, medium access control (MAC) signaling (e.g., MAC control elements (MAC CEs)), and/or the like. In some aspects, the configuration information may include an indication of one or more configuration parameters (e.g., already known to the UE) for selection by the UE, explicit configuration information for the UE to use to configure the UE, and/or the like.

In some aspects, the configuration information may indicate that the UE is to receive one or more reference signals associated with a sensing signal, measure the one or more reference signals, determine a sensing interference report for reducing interference for the sensing signal, transmit the sensing interference report, and/or the like. In some aspects, the configuration information may indicate that the UE is to receive the one or more reference signals based at least in part on an SMR and/or an SIMR.

As shown by reference number 810, the UE may configure the UE for communicating with the base station. In some aspects, the UE may configure the UE based at least in part on the configuration information. In some aspects, the UE may be configured to perform one or more operations described herein.

As shown by reference number 815, the base station may transmit, and the UE may receive, an indication of an SMR and/or an SIMR to use for measuring the one or more reference signals associated with the sensing signal. In some aspects, the SMR may be associated with a configured sensing beam. In some aspects, the SIMR may be associated with a non-precoded communication signal. In some aspects, the SIMR may identify multiple spatially different beams. In some aspects, the multiple spatially different beams may be associated with different reference signals or transmissions of a same reference signal. In some aspects, the one or more reference signals may include a channel state information (CSI) reference signal, a CSI interference measurement (IM) reference signal, a synchronization signal block (SSB), and/or the like. In some aspects, the one or more reference signals may be time division multiplexed, frequency division multiplexed, and/or the like.

In some aspects, the SMR may be associated with a CSI measurement resource (MR), a CSI configuration, and/or the like. In some aspects, the base station may indicate that the UE is to use the SMR based at least in part on the indication of the SMR identifying the CSI-MR that is associated with the SMR. In some aspects, the SIMR may be associated with a CSI-IM. In some aspects, the base station may indicate that the UE is to use the SIMR based at least in part on the indication of the SMR identifying the CSI-MR that is associated with the SIMR. In this way, the base station may indicate the SMR and/or the SIMR without requiring additional signaling configurations.

In some aspects, the SMR and/or the SIMR may be based at least in part on enhanced reference signals that may, for example, represent characteristics of waveforms (e.g., impulsive, FMCW, PMCW, and/or the like) such as duty-cycle, periodicity, power, and/or the like. In other words, the SMR and/or the SIMR may indicate a waveform type, a duty-cycle, a periodicity, a power metric, and/or the like for the one or more reference signals, the sensing signal, a communication signal, and/or the like.

As shown by reference number 820, the base station may transmit, and the UE may receive, one or more reference signals associated with a sensing signal. In some aspects, the one or more reference signals may include one or more transmissions of the sensing signal, one or more reference signals associated with a communication signal that may cause interference with the sensing signal, one or more reference signals associated with the sensing signal (e.g., having one or more characteristics of the sensing signal such as waveform, duty cycle, power, and/or the like), and/or the like.

In some aspects, the UE may receive a single reference signal (e.g., a single reference signal associated with the communication signal and/or the SIMR), of the one or more reference signals, via multiple spatially different beams. In some aspects, the UE may receive multiple reference signals (e.g., multiple reference signals associated with the communication signal and/or the SIMR), of the one or more reference signals, via the multiple spatially different beams. In some aspects, the UE may receive the single reference signal and/or the multiple reference signals using TDM and/or FDM.

In some aspects, the UE may receive at least one reference signal (e.g., that is associated with the sensing signals and/or the SMR) via repeated transmissions using a single beam (e.g., with a same spatial direction). For example, the at least one reference signal may be a repeated CSI reference signal with a same quasi co-location (CQL) type (e.g., QCL-TypeD).

As shown by reference number 825, the UE may determine (e.g., generate) a sensing interference report for reducing interference for the sensing signal. In some aspects, the sensing interference report may indicate one or more parameters for reducing interference for the sensing signal. In some aspects, the UE may determine the one or more parameters for reducing interference for the sensing signal based at least in part on the one or more reference signals associated with the sensing signal (e.g., associated with the SMR, the SIMR, the communication signal, the sensing signal, and/or the like). For example, the UE may use the SIMR as an interference reference signal (e.g., to define the interference reference signal) and/or may use the SMR as a sensing reference signal (e.g., to define the sensing reference signal).

In some aspects, the sensing interference report may indicate to avoid one or more spatial directions of a communication signal that may cause interference with the sensing signal, a preferred spatial direction for the communication signal, one or more power parameters to use for the communication signal, a modulation order to use for the communication signal, and/or the like. In some aspects, the sensing interference report may provide the indications using one or more precoders in a predetermined and/or configured codebook or identification of a set of beams (e.g., based at least in part on a precoding matrix indicator (PMI), a beam index (e.g., an SSB index, a CSI resource indicator (CRI), and/or the like), and/or the like). For example, the sensing interference report may provide an indication of a most preferred spatial interference direction, an indication of a least preferred spatial interference direction (e.g., associated with a communication signal), an indication that all spatial interference directions (e.g., identified in the SIMR) are acceptable, an indication that none of the spatial interference directions are acceptable, and/or the like.

In some aspects, the UE may be configured (e.g., via configuration information, the SMR, the SIMR, and/or the like) to indicate only one of the most preferred spatial interference direction or the least preferred spatial interference direction. In some aspects, the UE may be configured to indicate both of the most preferred spatial interference direction and the least preferred spatial interference direction. The UE be configured to indicate which spatial interference direction is most preferred and which is least preferred based at least in part on formatting of the indication (e.g., locations or orders within the indication of identifications associated with the most preferred spatial interference direction and the least preferred spatial interference direction), one or more explicit indications of which spatial interference direction is most preferred and which is least preferred, and/or the like. In some aspects, the UE may be configured to indicate that all spatial interference directions are acceptable or unacceptable based at least in part on indicating all spatial interference directions or no spatial interference directions (e.g., using a PMI, a beam index, and/or the like).

In some aspects, the sensing interference report may indicate a requested maximum modulation order (e.g., a Mod-Order) that may be applied to a communication signal. For example, the sensing interference report may use a CQI to indicate the requested maximum modulation order. In some aspects, the sensing interference report may indicate a requested maximum transmission power of the communication signal based at least in part on, for example, an indicated transmission power parameter.

In some aspects, the sensing interference report may indicate a PMI that is based at least in part on at least one restricted rank index, explicit CSI feedback, and/or the like. In some aspects, the restricted rank index may be based at least in part on a reception capability of the UE (e.g., implicitly determined based at least in part on configuration information, reception capabilities of the UE (such as a number of receiver antennas), and/or the like). In some aspects, the explicit CSI feedback may include CSI (e.g., between the base station and the UE) that is based at least in part on the SMR, CSI that is based at least in part on the SIMR, and/or the like.

As shown by reference number 830, the UE may transmit, and the base station may receive, the sensing interference report. In some aspects the UE may transmit the sensing interference report using one or more of a MAC CE, a physical uplink control channel (PUCCH) message, a CSI report, an enhanced CSI report, and/or the like.

As shown by reference number 835, the base station may determine one or more parameters for one or more signals. For example, the base station may determine one or more parameters for transmitting communication signals to an additional UE. The one or more parameters may include a beam direction, a transmission power, a modulation order, a rank index, and/or the like.

As shown by reference number 840, the base station may transmit the sensing signal and additional signals. For example, the base station may transmit the communication signals, to an additional UE, based at least in part on the one or more parameters for reducing interference for the sensing signal, as indicated in the sensing interference report.

Based at least in part on the UE transmitting the sensing interference report, the base station may have information to select one or more parameters for transmitting a communication signal to reduce interference, from the communication signal, for the sensing signal, which may allow the base station to use SDM for sensing services and communication services with improved Doppler resolution, range resolution, and scheduling when compared to FDM or TDM. In some aspects, the improved scheduling may conserve network resources that may otherwise have been wasted to avoid conflicting frequencies and/or transmission times (e.g., symbols, slots, and/or the like) between sensing signals and communication signals.

As indicated above, FIG. 8 is provided as an example. Other examples may differ from what is described with regard to FIG. 8.

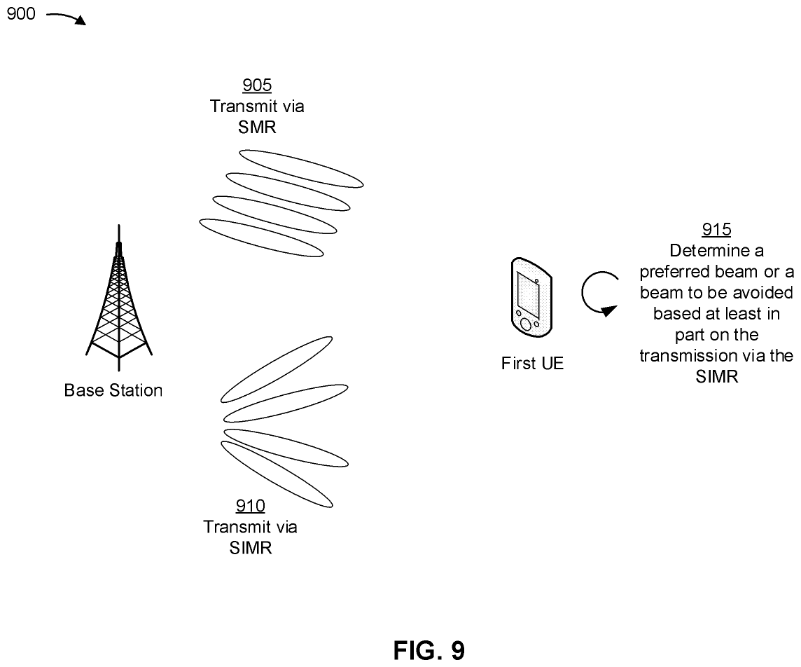

FIG. 9 is a diagram illustrating an example 900 associated with transmitting and/or receiving sensing interference reports, in accordance with the present disclosure. As shown in FIG. 9, a base station may transmit signals for reception by a first UE. The base station, the first UE, and one or more additional UEs may be part of a wireless network.

As shown by reference number 905, the base station may transmit one or more reference signals associated with an SMR (e.g., associated with a sensing signal). The base station may transmit the one or more reference signals via repeated transmission using a single beam. The single beam may be an already-identified beam for object detection of a particular object.

As shown by reference number 910, the base station may transmit one or more reference signals associated with an SIMR (e.g., associated with one or more communication signals). The base station may transmit the one or more reference signals via multiple spatially different beams. In some aspects, the base station may transmit the one or more reference signals using FDM or TDM so that the UE may differentiate multiple spatially different beams.

As shown by reference number 915, the UE may determine a preferred beam, or a beam to be avoided, based at least in part on the transmission via the SIMR. In some aspects, the UE may determine one or more spatial directions to avoid for the communication signal, one or more preferred spatial directions for the communication signal, one or more power parameters to use for the communication signal, a modulation order to use for the communication signal, and/or the like.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120 and/or the like) performs operations associated with sensing interference reports.

As shown in FIG. 10, in some aspects, process 1000 may include receiving one or more reference signals associated with a sensing signal (block 1010). For example, the UE (e.g., using receive processor 258, controller/processor 280, memory 282, and/or the like) may receive one or more reference signals associated with a sensing signal, as described above.

As further shown in FIG. 10, in some aspects, process 1000 may include transmitting a sensing interference report that indicates one or more parameters for reducing interference for the sensing signal (block 1020). For example, the UE (e.g., using transmit processor 264, controller/processor 280, memory 282, and/or the like) may transmit a sensing interference report that indicates one or more parameters for reducing interference for the sensing signal, as described above.

Process 1000 may include additional aspects, such as any single aspect or any combination of aspects described below and/or in connection with one or more other processes described elsewhere herein.

In a first aspect, the sensing interference report indicates the one or more parameters for reducing interference, for the sensing signal, based at least in part on a communication signal.

In a second aspect, alone or in combination with the first aspect, process 1000 includes one or more of: receiving an indication of an SMR associated with the one or more reference signals, or receiving an indication of an SIMR associated with the one or more reference signals.

In a third aspect, alone or in combination with one or more of the first and second aspects, the SMR is associated with a configured sensing beam, the SIMR is associated with a non-precoded communication signal, or some combination thereof.

In a fourth aspect, alone or in combination with one or more of the first through third aspects, the SMR is associated with a CS-MR, the SIMR is associated with a CSI-IM resource, or some combination thereof.

In a fifth aspect, alone or in combination with one or more of the first through fourth aspects, one or more of the SMR or the SIMR is based at least in part on one or more of: a waveform type for the sensing signal, a duty-cycle for the sensing signal, a periodicity for the sensing signal, or a power metric for the sensing signal.

In a sixth aspect, alone or in combination with one or more of the first through fifth aspects, process 1000 includes determining the sensing interference report based at least in part on using the SIMR as an interference reference signal and using the SMR as a sensing reference signal.

In a seventh aspect, alone or in combination with one or more of the first through sixth aspects, the SIMR identifies multiple spatially different beams.

In an eighth aspect, alone or in combination with one or more of the first through seventh aspects, process 1000 includes receiving a single reference signal, of the one or more reference signals, via the multiple spatially different beams, or receiving different reference signals, of the one or more reference signals, via the multiple spatially different beams.

In a ninth aspect, alone or in combination with one or more of the first through eighth aspects, process 1000 includes receiving at least one reference signal, of the one or more reference signals, that is associated with the SIMR via the multiple spatially different beams using one or more of TDM or FDM.

In a tenth aspect, alone or in combination with one or more of the first through ninth aspects, process 1000 includes receiving at least one reference signal, of the one or more reference signals, that is associated with the SMR via repeated transmissions using a single beam.

In an eleventh aspect, alone or in combination with one or more of the first through tenth aspects, the sensing interference report includes one or more of: an indication to avoid one or more spatial directions of a communication signal that may cause interference with the sensing signal, an indication of one or more preferred spatial directions for the communication signal, an indication of one or more power parameters to use for the communication signal, or an indication of a modulation order to use for the communication signal.

In a twelfth aspect, alone or in combination with one or more of the first through eleventh aspects, the one or more parameters for reducing interference for the sensing signal include a PMI that is based at least in part on one or more of: at least one restricted rank index, or an explicit CSI feedback.

In a thirteenth aspect, alone or in combination with one or more of the first through twelfth aspects, process 1000 includes determining the at least one restricted rank index based at least in part on one or more of: a reception capability of the UE, or configuration information received via a base station.

In a fourteenth aspect, alone or in combination with one or more of the first through thirteenth aspects, the explicit CSI feedback comprises one or more of: CSI, between a base station and the UE, that is based at least in part on an SMR, or CSI, between the base station and the UE, that is based at least in part on an SIMR.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with the present disclosure. Example process 1100 is an example where the base station (e.g., base station 110 and/or the like) performs operations associated with sensing interference reports.

As shown in FIG. 11, in some aspects, process 1100 may include transmitting one or more reference signals associated with a sensing signal (block 1110). For example, the base station (e.g., using transmit processor 220, controller/processor 240, memory 242, and/or the like) may transmit one or more reference signals associated with a sensing signal, as described above.

As further shown in FIG. 11, in some aspects, process 1100 may include receiving a sensing interference report that indicates one or more parameters for reducing interference for the sensing signal (block 1120). For example, the base station (e.g., using receive processor 238, controller/processor 240, memory 242, and/or the like) may receive a sensing interference report that indicates one or more parameters for reducing interference for the sensing signal, as described above.

Process 1100 may include additional aspects, such as any single aspect or any combination of aspects described below and/or in connection with one or more other processes described elsewhere herein.

In a first aspect, the sensing interference report indicates the one or more parameters for reducing interference, for the sensing signal, based at least in part on a communication signal.

In a second aspect, alone or in combination with the first aspect, process 1100 includes one or more of: transmitting an indication of an SMR associated with the one or more reference signals, or transmitting an indication of an SIMR associated with the one or more reference signals.

In a third aspect, alone or in combination with one or more of the first and second aspects, the SMR is associated with a configured sensing beam, the SIMR is associated with a non-precoded communication signal, or some combination thereof.

In a fourth aspect, alone or in combination with one or more of the first through third aspects, the SMR is associated with a CSI-MR, the SIMR is associated with a CSI-IM resource, or some combination thereof.

In a fifth aspect, alone or in combination with one or more of the first through fourth aspects, one or more of the SMR or the SIMR is based at least in part on one or more of: a waveform type for the sensing signal, a duty-cycle for the sensing signal, a periodicity for the sensing signal, or a power metric for the sensing signal.

In a sixth aspect, alone or in combination with one or more of the first through fifth aspects, the SIMR identifies multiple spatially different beams.

In a seventh aspect, alone or in combination with one or more of the first through sixth aspects, process 1100 includes transmitting a single reference signal, of the one or more reference signals, via the multiple spatially different beams, or transmitting different reference signals, of the one or more reference signals, via the multiple spatially different beams.

In an eighth aspect, alone or in combination with one or more of the first through seventh aspects, process 1100 includes transmitting at least one reference signal, of the one or more reference signals, that is associated with the SIMR via the multiple spatially different beams using one or more of TDM or FDM.

In a ninth aspect, alone or in combination with one or more of the first through eighth aspects, process 1100 includes transmitting at least one reference signal, of the one or more reference signals, that is associated with the SMR via repeated transmissions using a single beam.

In a tenth aspect, alone or in combination with one or more of the first through ninth aspects, the sensing interference report includes one or more of: an indication to avoid one or more spatial directions of a communication signal that may cause interference with the sensing signal, an indication of one or more preferred spatial directions for the communication signal, an indication of one or more power parameters to use for the communication signal, or an indication of a modulation order to use for the communication signal.

In an eleventh aspect, alone or in combination with one or more of the first through tenth aspects, the one or more parameters for reducing interference for the sensing signal include a PMI that is based at least in part on one or more of: at least one restricted rank index; or an explicit CSI feedback.

In a twelfth aspect, alone or in combination with one or more of the first through eleventh aspects, the explicit CSI feedback comprises one or more of: CSI, between the base station and a UE, that is based at least in part on an SMR, or CSI, between the base station and a UE, that is based at least in part on an SIMR.

In a thirteenth aspect, alone or in combination with one or more of the first through twelfth aspects, process 1100 includes determining, based at least in part on the sensing interference report, one or more parameters for transmitting at least one additional signal; and transmitting the sensing signal and the at least one additional signal.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

The following provides an overview of some Aspects of the present disclosure:

Aspect 1: A method of wireless communication performed by a user equipment (UE), comprising: receiving one or more reference signals associated with a sensing signal; and transmitting a sensing interference report that indicates one or more parameters for reducing interference for the sensing signal.

Aspect 2: The method of Aspect 1, wherein the sensing interference report indicates the one or more parameters for reducing interference, for the sensing signal, based at least in part on a communication signal.

Aspect 3: The method of any of Aspects 1-2, further comprising one or more of: receiving an indication of a sensing measurement resource associated with the one or more reference signals; or receiving an indication of a sensing interference measurement resource associated with the one or more reference signals.

Aspect 4: The method of Aspect 3, wherein the sensing measurement resource is associated with a configured sensing beam, wherein the sensing interference measurement resource is associated with a non-precoded communication signal, or some combination thereof.

Aspect 5: The method of Aspect 3, wherein the sensing measurement resource is associated with a channel state information measurement resource, wherein the sensing interference measurement resource is associated with a channel state information interference measurement resource, or some combination thereof.

Aspect 6: The method of any of Aspects 3-5, wherein one or more of the sensing measurement resource or the sensing interference measurement resource is based at least in part on one or more of: a waveform type for the sensing signal; a duty-cycle for the sensing signal; a periodicity for the sensing signal; or a power metric for the sensing signal.

Aspect 7: The method of any of Aspects 3-6, further comprising: determining the sensing interference report based at least in part on using the sensing interference measurement resource as an interference reference signal and using the sensing measurement resource as a sensing reference signal.

Aspect 8: The method of any of Aspects 3-7, wherein the sensing interference measurement resource identifies multiple spatially different beams.

Aspect 9: The method of Aspect 8, further comprising: receiving a single reference signal, of the one or more reference signals, via the multiple spatially different beams, or receiving different reference signals, of the one or more reference signals, via the multiple spatially different beams.

Aspect 10: The method of any of Aspects 8-9, further comprising: receiving at least one reference signal, of the one or more reference signals, that is associated with the sensing interference measurement resource via the multiple spatially different beams using one or more of time division multiplexing or frequency division multiplexing.

Aspect 11: The method of Aspect 3, further comprising: receiving at least one reference signal, of the one or more reference signals, that is associated with the sensing measurement resource via repeated transmissions using a single beam.

Aspect 12: The method of any of Aspects 1-11, wherein the sensing interference report includes one or more of: an indication to avoid one or more spatial directions of a communication signal that may cause interference with the sensing signal, an indication of one or more preferred spatial directions for the communication signal, an indication of one or more power parameters to use for the communication signal, or an indication of a modulation order to use for the communication signal.

Aspect 13: The method of any of Aspects 1-12, wherein the one or more parameters for reducing interference for the sensing signal includes a precoding matrix indicator that is based at least in part on one or more of: at least one restricted rank index; or an explicit channel state information feedback.

Aspect 14: The method of Aspect 13, further comprising determining the at least one restricted rank index based at least in part on one or more of: a reception capability of the UE, or configuration information received via a base station.

Aspect 15: The method of Aspect 13, wherein the explicit channel state information feedback comprises one or more of: channel state information, between a base station and the UE, that is based at least in part on a sensing measurement resource, or channel state information, between the base station and the UE, that is based at least in part on a sensing interference measurement resource.

Aspect 16: A method of wireless communication performed by a base station, comprising: transmitting one or more reference signals associated with a sensing signal; and receiving a sensing interference report that indicates one or more parameters for reducing interference for the sensing signal.

Aspect 17: The method of Aspect 16, wherein the sensing interference report indicates the one or more parameters for reducing interference, for the sensing signal, based at least in part on a communication signal.

Aspect 18: The method of any of Aspects 16-17, further comprising one or more of: transmitting an indication of a sensing measurement resource associated with the one or more reference signals; or transmitting an indication of a sensing interference measurement resource associated with the one or more reference signals.

Aspect 19: The method of Aspect 18, wherein the sensing measurement resource is associated with a configured sensing beam, wherein the sensing interference measurement resource is associated with a non-precoded communication signal, or some combination thereof.

Aspect 20: The method of Aspect 18, wherein the sensing measurement resource is associated with a channel state information measurement resource, wherein the sensing interference measurement resource is associated with a channel state information interference measurement resource, or some combination thereof.

Aspect 21: The method of any of Aspects 18-20, wherein one or more of the sensing measurement resource or the sensing interference measurement resource is based at least in part on one or more of: a waveform type for the sensing signal; a duty-cycle for the sensing signal; a periodicity for the sensing signal; or a power metric for the sensing signal.

Aspect 22: The method of any of Aspects 18-21, wherein the sensing interference measurement resource identifies multiple spatially different beams.

Aspect 23: The method of Aspect 22, further comprising: transmitting a single reference signal, of the one or more reference signals, via the multiple spatially different beams, or transmitting different reference signals, of the one or more reference signals, via the multiple spatially different beams.

Aspect 24: The method of any of Aspects 22-23, further comprising: transmitting at least one reference signal, of the one or more reference signals, that is associated with the sensing interference measurement resource via the multiple spatially different beams using one or more of time division multiplexing or frequency division multiplexing.

Aspect 25: The method of Aspect 18, further comprising: transmitting at least one reference signal, of the one or more reference signals, that is associated with the sensing measurement resource via repeated transmissions using a single beam.

Aspect 26: The method of any of Aspects 16-25, wherein the sensing interference report includes one or more of: an indication to avoid one or more spatial directions of a communication signal that may cause interference with the sensing signal, an indication of one or more preferred spatial directions for the communication signal, an indication of one or more power parameters to use for the communication signal, or an indication of a modulation order to use for the communication signal.

Aspect 27: The method of any of Aspects 16-26, wherein the one or more parameters for reducing interference for the sensing signal includes a precoding matrix indicator that is based at least in part on one or more of: at least one restricted rank index; or an explicit channel state information feedback.

Aspect 28: The method of Aspect 27, wherein the explicit channel state information feedback comprises one or more of: channel state information, between the base station and a user equipment (UE), that is based at least in part on a sensing measurement resource, or channel state information, between the base station and a UE, that is based at least in part on a sensing interference measurement resource.

Aspect 29: The method of any of Aspects 16-28, further comprising: determining, based at least in part on the sensing interference report, one or more parameters for transmitting at least one additional signal; and transmitting the sensing signal and the at least one additional signal.

Aspect 30: A method of wireless communication performed by a user equipment (UE), comprising: determining channel state information (CSI) based at least in part on a first reference signal and interference of a second reference signal that is associated with a sensing signal; and transmitting a CSI report that is based at least in part on a measurement of the first reference signal and the interference of the second reference signal.

Aspect 31: The method of Aspect 30, wherein the second reference signal is associated with a waveform that includes one or more of: a signal transmitted via an ultra-wide bandwidth, an impulsive signal, a signal transmitted using a frequency-modulated continuous wave, or a signal transmitted using a time-modulated continuous wave.

Aspect 32: The method of any of Aspects 30-31, further comprising: receiving an indication of one or more of a CSI reference resource or a CSI-IM resource, wherein determining the CSI based at least in part on the first reference signal and the interference of the second reference signal comprises: determining the CSI based at least in part on the first reference signal and the interference of the second reference signal as indicated by the one or more of the CSI reference resource or the CSI-IM resource.

Aspect 33: The method of Aspect 32, wherein the one or more of the CSI reference resource or the CSI-IM resource identifies one or more parameters of the second reference signal, the one or more parameters including one or more of: a waveform type for the sensing signal, a duty-cycle for the sensing signal, a periodicity for the sensing signal, or a power metric for the sensing signal.

Aspect 34: The method of any of Aspects 32-33, wherein the one or more of the CSI reference resource or the CSI-IM resource indicates that the first reference signal is configured to be transmitted via a set of resources and that the second reference signal is configured to be transmitted impulsively within a proper subset of the set of resources.

Aspect 35: The method of Aspect 34, wherein determining the CSI based at least in part on the first reference signal and the interference of the second reference signal comprises one or more of: determining a first set of CSI parameters including one or more of a rank index, a precoding matrix indicator, or a channel quality indicator for the proper subset of the set of resources and a second set of CSI parameters including one or more of a rank index, a precoding matrix indicator, or a channel quality indicator for resources outside of the proper subset of the set of resources, or determining a joint set of CSI parameters including one or more of a rank index, a precoding matrix indicator, or a channel quality indicator based at least in part on the second reference signal being transmitted impulsively within the proper subset of the set of resources.

Aspect 36: A method of wireless communication performed by a base station, comprising: transmitting a first reference signal and a second reference signal that is associated with a sensing signal; and receiving a CSI report that is based at least in part on a measurement of the first reference signal and interference of the second reference signal.

Aspect 37: The method of Aspect 36, wherein the second reference signal is associated with a waveform that includes one or more of: a signal transmitted via an ultra-wide bandwidth, an impulsive signal, a signal transmitted using a frequency-modulated continuous wave, or a signal transmitted using a time-modulated continuous wave.

Aspect 38: The method of any of Aspects 36-37, further comprising: transmitting an indication of one or more of a CSI reference resource or a CSI-IM resource, wherein the CSI report is based at least in part on the first reference signal and the interference of the second reference signal as indicated by one or more of the CSI reference resource or the CSI-IM resource.

Aspect 39: The method of Aspect 38, wherein the one or more of the CSI reference resource or the CSI-IM resource identifies one or more parameters of the second reference signal, the one or more parameters including one or more of: a waveform type for the sensing signal, a duty-cycle for the sensing signal, a periodicity for the sensing signal, or a power metric for the sensing signal.

Aspect 40: The method of any of Aspects 38-39, wherein the one or more of the CSI reference resource or the CSI-IM resource indicates that the first reference signal is configured to be transmitted via a set of resources and that the second reference signal is configured to be transmitted impulsively within a proper subset of the set of resources.

Aspect 41: The method of Aspect 40, wherein the CSI report indicates one or more of a first set of CSI parameters including one or more of a rank index, a precoding matrix indicator, or a channel quality indicator for the proper subset of the set of resources and a second set of CSI parameters including one or more of a rank index, a precoding matrix indicator, or a channel quality indicator for resources outside of the proper subset of the set of resources, or a joint set of CSI parameters including one or more of a rank index, a precoding matrix indicator, or a channel quality indicator based at least in part on the second reference signal being transmitted impulsively within the proper subset of the set of resources.

Aspect 42: An apparatus for wireless communication at a device, comprising a processor; memory coupled with the processor; and instructions stored in the memory and executable by the processor to cause the apparatus to perform the method of one or more Aspects of Aspects 1-41.

Aspect 43: A device for wireless communication, comprising a memory and one or more processors coupled to the memory, the memory and the one or more processors configured to perform the method of one or more Aspects of Aspects 1-41.

Aspect 44: An apparatus for wireless communication, comprising at least one means for performing the method of one or more Aspects of Aspects 1-41.

Aspect 45: A non-transitory computer-readable medium storing code for wireless communication, the code comprising instructions executable by a processor to perform the method of one or more Aspects of Aspects 1-41.

Aspect 46: A non-transitory computer-readable medium storing a set of instructions for wireless communication, the set of instructions comprising one or more instructions that, when executed by one or more processors of a device, cause the device to perform the method of one or more Aspects of Aspects 1-41.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive one or more reference signals associated with a sensing signal; and
transmit a sensing interference report that indicates one or more parameters for reducing interference for the sensing signal.

2. The UE of claim 1, wherein the sensing interference report indicates the one or more parameters for reducing interference, for the sensing signal, based at least in part on a communication signal.

3. The UE of claim 1, wherein the one or more processors are further configured to one or more of:
receive an indication of a sensing measurement resource associated with the one or more reference signals; or
receive an indication of a sensing interference measurement resource associated with the one or more reference signals.

4. The UE of claim 3, wherein the sensing measurement resource is associated with a configured sensing beam,
wherein the sensing interference measurement resource is associated with a non-precoded communication signal, or
some combination thereof.

5. The UE of claim 3, wherein the sensing measurement resource is associated with a channel state information measurement resource,
wherein the sensing interference measurement resource is associated with a channel state information interference measurement resource, or
some combination thereof.

6. The UE of claim 3, wherein one or more of the sensing measurement resource or the sensing interference measurement resource is based at least in part on one or more of:
a waveform type for the sensing signal;
a duty-cycle for the sensing signal;
a periodicity for the sensing signal; or
a power metric for the sensing signal.

7. The UE of claim 3, wherein the one or more processors are further configured to:
determine the sensing interference report based at least in part on using the sensing interference measurement resource as an interference reference signal and using the sensing measurement resource as a sensing reference signal.

8. The UE of claim 3, wherein the sensing interference measurement resource identifies multiple spatially different beams.

9. The UE of claim 8, wherein the one or more processors are further configured to:
receive at least one reference signal, of the one or more reference signals, that is associated with the sensing interference measurement resource via the multiple spatially different beams using one or more of time division multiplexing or frequency division multiplexing.

10. The UE of claim 3, wherein the one or more processors are further configured to:
receive at least one reference signal, of the one or more reference signals, that is associated with the sensing measurement resource via repeated transmissions using a single beam.

11. The UE of claim 1, wherein the sensing interference report includes one or more of:
an indication to avoid one or more spatial directions of a communication signal that may cause interference with the sensing signal,
an indication of one or more preferred spatial directions for the communication signal,
an indication of one or more power parameters to use for the communication signal, or
an indication of a modulation order to use for the communication signal.

12. The UE of claim 1, wherein the one or more parameters for reducing interference for the sensing signal includes a precoding matrix indicator that is based at least in part on one or more of:
at least one restricted rank index; or
an explicit channel state information feedback.

13. The UE of claim 12, wherein the one or more processors are further configured to determine the at least one restricted rank index based at least in part on one or more of:
a reception capability of the UE, or
configuration information received via a base station.

14. The UE of claim 12, wherein the explicit channel state information feedback comprises one or more of:
channel state information, between a base station and the UE, that is based at least in part on a sensing measurement resource, or
channel state information, between the base station and the UE, that is based at least in part on a sensing interference measurement resource.

15. A base station for wireless communication, comprising:
a memory; and
one or more processors, coupled to the memory, configured to:
transmit one or more reference signals associated with a sensing signal; and
receive a sensing interference report that indicates one or more parameters for reducing interference for the sensing signal.

16. The base station of claim 15, wherein the sensing interference report indicates the one or more parameters for reducing interference, for the sensing signal, based at least in part on a communication signal.

17. The base station of claim 15, wherein the one or more processors are further configured to one or more of:
transmit an indication of a sensing measurement resource associated with the one or more reference signals; or
transmit an indication of a sensing interference measurement resource associated with the one or more reference signals.

18. The base station of claim 17, wherein one or more of the sensing measurement resource or the sensing interference measurement resource is based at least in part on one or more of:
a waveform type for the sensing signal;
a duty-cycle for the sensing signal;
a periodicity for the sensing signal; or
a power metric for the sensing signal.

19. The base station of claim 17, wherein the sensing interference measurement resource identifies multiple spatially different beams.

20. The base station of claim 19, wherein the one or more processors are further configured to:
transmit at least one reference signal, of the one or more reference signals, that is associated with the sensing interference measurement resource via the multiple spatially different beams using one or more of time division multiplexing or frequency division multiplexing.

21. The base station of claim 17, wherein the one or more processors are further configured to:
transmit at least one reference signal, of the one or more reference signals, that is associated with the sensing measurement resource via repeated transmissions using a single beam.

22. The base station of claim 15, wherein the sensing interference report includes one or more of:
an indication to avoid one or more spatial directions of a communication signal that may cause interference with the sensing signal,
an indication of one or more preferred spatial directions for the communication signal,
an indication of one or more power parameters to use for the communication signal, or
an indication of a modulation order to use for the communication signal.

23. The base station of claim 15, wherein the one or more parameters for reducing interference for the sensing signal includes a precoding matrix indicator that is based at least in part on one or more of:
at least one restricted rank index; or
an explicit channel state information feedback.

24. The base station of claim 16, wherein the one or more processors are further configured to:
determine, based at least in part on the sensing interference report, one or more parameters for transmitting at least one additional signal; and
transmit the sensing signal and the at least one additional signal.

25. A method of wireless communication performed by a user equipment (UE), comprising:
receiving one or more reference signals associated with a sensing signal; and
transmitting a sensing interference report that indicates one or more parameters for reducing interference for the sensing signal.

26. The method of claim 25, wherein the sensing interference report indicates the one or more parameters for reducing interference, for the sensing signal, based at least in part on a communication signal.

27. The method of claim 25, further comprising one or more of:
receiving an indication of a sensing measurement resource associated with the one or more reference signals; or
receiving an indication of a sensing interference measurement resource associated with the one or more reference signals.

28. A method of wireless communication performed by a base station, comprising:
transmitting one or more reference signals associated with a sensing signal; and
receiving a sensing interference report that indicates one or more parameters for reducing interference for the sensing signal.

29. The method of claim 28, wherein the sensing interference report indicates the one or more parameters for reducing interference, for the sensing signal, based at least in part on a communication signal.

30. The method of claim 28, further comprising one or more of:
transmitting an indication of a sensing measurement resource associated with the one or more reference signals; or
transmitting an indication of a sensing interference measurement resource associated with the one or more reference signals.
